(19) United States
(12) Patent Application Publication
(10) Pub. No.: US 2025/0065534 A1
(43) Pub. Date: Feb. 27, 2025

(54) Method and device for manufacturing pavement elements made of concrete, and pavement element made of concrete

(71) Applicant: Godelmann GmbH & Co. KG, Fensterbach (DE)

(72) Inventor: Bernhard Godelmann, Kummersbruck (DE)

(21) Appl. No.: 18/848,594

(22) PCT Filed: Mar. 1, 2023
(86) PCT No.: PCT/EP2023/055164

§ 371 Date: Sep. 19, 2024

(30) Foreign Application Priority Data
Mar. 21, 2022 (DE) 10 2022 106 480.8

(51) Int. Cl. B28B 3/10; B32B 13/04; E01C 5/06

(52) U.S. Cl. CPC B28B 3/10; B32B 13/04; E01C 5/065; B32B 2250/02; B32B 2419/04

(57) ABSTRACT

The invention relates to a method for manufacturing pavement elements made of concrete for manufacturing concrete paving stones or concrete slabs by a paving stone machine. The pavement elements are produced as multi-layer pavement elements {1} and have at least one core concrete layer manufactured from a core concrete and at least one face concrete layer manufactured from a face concrete. In the method, the core concrete is introduced into at least one mold and compressed. Subsequently the face concrete is additionally introduced onto the compressed core concrete and is likewise compressed, and the core concrete and the face concrete are cured.

### BACKGROUND OF THE INVENTION

The invention relates to a method and device for manufacturing floor covering elements made of concrete, more particularly for manufacturing concrete blocks and/or concrete slabs, which are suitable for the creation of a paving and also to a floor covering element made of concrete.

Floor covering elements made of concrete, namely concrete blocks for the creation of surface coverings, are sufficiently known from prior art. Such floor covering elements or concrete blocks, which are usually so-called shaped concrete blocks, are to be understood as concrete floor covering elements, which, depending on the type of application, can be slab-like or stone-like in shape and are usually also referred to as concrete paving stones. In most cases, these concrete blocks are laid in bond to create a surface covering, which is why concrete blocks of the type mentioned are often also referred to as composite concrete blocks or composite paving stones.

Multi-layer concrete blocks and concrete paving stones are also known here, which comprise at least one core layer and one face layer, wherein the core layer is usually made of a core concrete and forms a core of the concrete block and wherein the face layer is usually made of a face concrete and forms the walkable or drivable concrete-block upper face, namely its visible surface.

Manufacturing concrete blocks is usually carried out with the aid of formwork molds and is carried out, for example, using a machine, wherein it is known that concrete paving stones are manufactured in so-called and specially designed paving stone machines or systems. As a rule, the concrete paving stones are manufactured in the desired stone formats with the help of appropriate formwork mold.

Not least due to landscape planning or urban planning aspects, more and more attention has recently been paid to the visual design and appearance of concrete blocks of the type mentioned. In particular, there is an increasing demand for concrete blocks whose visible surface is structured and/or colored in a special way and thus comprises a certain surface structure, a desired visual and/or haptic surface effect and/or a desired coloring.

In this regard, it has become known from prior art, for example, that during the manufacturing of the concrete blocks, the face concrete layer is additionally treated for structuring same before curing, for example, by embossing or forming recesses or elevations, as specified in DE 10 2010 025 024 A1, for example.

It has also become known from prior art that the face concrete layer is treated with structuring or coloring material by adding or applying it before curing in order to introduce a surface design. For example, DE 10 2004 062 656 A1 describes a method for manufacturing concrete blocks in which a portion of a finishing material is thrown onto the face concrete layer before curing by means of a specially designed application device.

However, the disadvantage of these well-known methods is that the treatment or application steps required in the manufacturing method for manufacturing the surface design are time-consuming and therefore cost-intensive, and also place high constructive demands, as special treatment and/or application devices are required in each case. Therefore, there is still a need for improved methods for manufacturing concrete blocks.

### SUMMARY OF THE INVENTION

The object of the present invention is therefore to provide a method for manufacturing floor covering elements which enables a simple and simultaneously flexible and fast manufacturing of floor covering elements with special surface effects by machine and which, in particular, allows manufacturing a desired surface play.

This object is solved by means the method for manufacturing floor covering elements according to Patent Claim 1. Furthermore, a device for manufacturing floor covering elements according to Patent Claim 12 and a floor covering element according to Patent Claim 17 are specified to solve the object. Other favorable aspects, details and embodiments of the invention result from the dependent claims, the description and the drawings.

The present invention provides a method for manufacturing floor covering elements made of concrete, in particular, a method for manufacturing concrete paving stones or concrete slabs by means of a paving stone machine. With the method according to the invention, the floor covering elements are manufactured as multi-layer floor covering elements and comprise at least one core concrete layer made from a core concrete and at least one face concrete layer made from a face concrete. In the case of the method, the core concrete is first introduced into at least one mold and compressed. The face concrete is then charged onto the compressed core concrete and also compressed. Finally, the core and face concrete are cured. In accordance with an essential aspect of the present method, at least a first face concrete mixture and at least a second face concrete mixture are prepared and provided for manufacturing the face concrete layer. The face concrete used to be charged onto the compressed core concrete comprise at least one proportion of the first face concrete mixture and at least one proportion of the second face concrete mixture, wherein the first face concrete mixture is a structurally dense concrete material and the second face concrete mixture is a non-fines porous concrete material.

The manufacturing of the floor covering element made of concrete, which in the present case can also be understood as a concrete paving stone and is preferably a “concrete paving stone” in accordance with DIN EN 1338, is carried out by machine using the method according to the invention, favorably by machine in a paving stone machine which is configured for automated, preferably controlled, in particular, program-controlled production. In the present case, such a paving stone machine can also be understood as a device or system for manufacturing concrete paving stones or concrete slabs. In other words, the manufacturing method is also automated, preferably controlled, in particular, program-controlled.

The “mold” used to carry out the method can also be understood as a formwork mold and is preferably a mold provided for the paving stone machine, configured for a single or for a plurality of floor covering elements, i.e., one mold can be used to form one or a plurality of floor covering elements, wherein, in the latter case, a plurality of recesses are built in a basic mold, each of which can also be understood as a single mold. The floor covering elements are preferably manufactured in a desired format or final format, which in this case can also be referred to as nominal format or nominal size or nominal dimension.

For the purposes of the present invention, the term “face concrete mixture” is understood to mean a concrete material used for manufacturing the face concrete layer, i.e., a concrete material from which the face concrete layer is formed. Each of the “face concrete mixtures” is part or proportion of the concrete material used to form the face concrete layer, which is referred to as “face concrete” in the sense according to the invention. According to the understanding of the present invention, the “face concrete mixture”—and consequently also the “face concrete”-is thus not limited to a structurally dense concrete material but can also be a porous or non-fines porous concrete material.

In the method according to the invention, at least one proportion of a first face concrete mixture and at least one proportion of a second face concrete mixture is used as face concrete for manufacturing the face concrete layer, wherein the at least two face concrete mixtures differ from each other. The face concrete for manufacturing the face concrete layer can therefore also be understood as a proportional composition or combination of at least two face concrete mixtures.

In this case, the at least two face concrete mixtures in the face concrete or in the face concrete material exist in unmixed form or are at most partially mixed or partially blended and, in particular, are not completely mixed in such a way that the face concrete is a uniform face concrete mixture or a uniform face concrete material. In other words, the at least two face concrete mixtures together form the face concrete as face concrete mixtures existing side by side so that the face concrete layer produced therefrom comprises at least two face concrete sections, each of which is made of different face concrete material.

The at least two face concrete mixtures differ from each other in preferably at least one characteristic that affects and/or influences the visual and/or haptic surface appearance of the face concrete layer.

In particular, the face concrete mixtures differ in the base material used to prepare the respective face concrete mixture, for example in the aggregate and/or in an additive material used to prepare the respective face concrete mixture. Advantageously, the at least one distinguishing characteristic of the various face concrete mixtures is, for example, the type of aggregate, the color of the aggregate, the coarseness or fineness of the aggregate or the particle size distribution of the aggregate. Additive or alternative, the at least one distinguishing characteristic of the various face concrete mixtures can also be the type or color of an additive material or another characteristic that influences the visual and/or haptic appearance of the surface of the face concrete layer. Of course, the face concrete mixtures can also differ in a plurality of the characteristics mentioned.

For the purposes according to the invention, “aggregate” is to be understood as a granular material, in particular, natural and artificial aggregates, such as those used as the basic material for manufacturing concrete. The stone particles can be either round particles or in broken form. In the present case, the aggregate for manufacturing the face concrete layer can also be described as sand.

According to the invention, the face concrete mixtures of the face concrete used for manufacturing the face concrete layer also differ in that one of the face concrete mixtures is a structurally dense concrete material and the other face concrete mixture is a non-fines porous concrete material. The face concrete mixtures can differ only in these characteristics, namely “structurally dense” or “non-fines porous”, or in addition to this in other of the other possible distinguishing characteristics mentioned above.

Due to the use of at least two face concrete mixtures for manufacturing the face concrete layer according to the invention, it comprises at least two different sections in the finished floor covering elements, in particular, surface or surface sections, wherein a first section essentially or mainly comprises the material of the first face concrete mixture and therefore essentially comprises a first visual and/or haptic surface appearance and wherein a second section essentially or mainly comprises the material of the second face concrete mixture and therefore essentially has a different, second visual and/or haptic surface appearance. In the present case, the surface sections are also referred to as face concrete layer sections.

By means of the method according to the invention, floor covering elements with a special surface effect or surface play can be manufactured. In particular, the change or transition from the first to the second section-and vice versa-can be regarded as a surface effect or surface play.

In particular, the present method can be used to produce floor covering elements made of concrete in which the upper face formed by the face concrete layer, which is visible in the installed state of use of the floor covering element, has a natural appearance and is very similar to a natural stone. This natural appearance can be further enhanced by the use of each proportion of a structurally dense face concrete mixture and a pervious face concrete mixture. In particular, this also makes it possible to produce concrete paving stones that appear visually and/or haptically like limestone or sand-lime brick, for example concrete paving stones with a travertine look, i.e., concrete paving stones that resemble or equal to natural travertine in their appearance and feel.

Preferably, the first and second face concrete mixtures are each prepared and provided in an own storage container. The advantage here is that each face concrete mixture can be prepared and stored in a suitable volume with the specified or desired components and in the specified or desired composition without the individual face concrete mixtures being mixed or partially mixed or partially blended ahead of time.

It is to be understood, however, that in the sense of the present invention it is also conceivable that the face concrete mixtures can be introduced together into a container or a feeding device or together into a filling device in order to finally be fed into the mold. In this way, for example, a chaotic feeding of the face concrete, which consists of parts of the face concrete mixtures, into the mold is possible. In particular, this can also create and enhance the effect that, in addition to the face concrete layer sections, which comprise only or mainly the first or second face concrete mixture, mixed sections or mixed areas are also formed, which comprise to varying degrees both the first as well as the second face concrete mixture, wherein the first and second face concrete mixtures are present in different proportions to each other in the various mixing areas, preferably mixed, for example, almost completely or completely mixed.

Preferably, the first face concrete mixture is prepared with an aggregate containing a first particle size distribution or average particle size, and the second face concrete mixture is prepared with an aggregate containing a second particle size distribution or average particle size, wherein the first and second particle size distribution or average particle size are different. This means that the first and second particle size distributions of the respective aggregates for manufacturing the first and second face concrete mixture are chosen differently. In simple terms, for example, sand of various degrees of fineness is used for manufacturing the first and second face concrete mixture.

This results in favorably different surface sections in the face concrete layer, namely at least a finer or smoother face concrete section and at least one coarser or more porous or rougher face concrete section. In the present case, the terms “face concrete section” and “section” are used synonymously. The terms “finer” and “coarser” or “rougher” and “smoother” are to be understood here in such a way that one of the at least two face concrete sections appears “finer” or “coarser” relative to the other section. This creates a favorable surface play in or on the face concrete layer from fine to coarse and vice versa.

The aggregates can be divided into so-called particle groups or particle sizes and can be represented by means of so-called grading curves. For the purposes of the present invention, the particle size specifies an average stone particle diameter of the stone particles in the particle composition or a range of a stone particle diameter (with smallest and largest particle size). The aggregate can be understood as a mixture of aggregates, wherein the aggregates present in the mixture can comprise different diameters, but the diameters are within a specified or limited range, preferably within a narrowly defined range. The aggregates present in the aggregate thus comprise a predetermined particle size distribution, preferably in a narrow area, and form a particle group. In the present case, the particle size is also to be understood as a value for the average rock particle diameter of an aggregate.

For example, the first particle size distribution is in a range of 0 mm to 2 mm or 1mm to 2 mm (this can also be referred to as the 0/2 or 1/2 particle group). For example, the second particle size distribution is in a range of 2 mm to 4 mm or 3 mm to 4 mm (this can also be referred to as particle group 2/4 or 3/4). The particle sizes of the aggregates used for manufacturing the first and second face concrete mixtures therefore correspond preferably to different grading curves. The surface play created in this way can also be understood as a surface play of sections with different densities, namely as an interplay between “denser” and “less dense” sections.

It is to be understood that the different aggregates with which the various face concrete mixtures are prepared may also differ in color and/or in terms of other optical and/or haptic characteristics, either or in addition to the particle size distribution.

In accordance with a preferred embodiment variant of the present method, the first and second face concrete mixtures are introduced into the mold simultaneously or in successive steps for charging onto the compressed core concrete of the core concrete layer. In this case, the face concrete mixtures are preferably fed via at least one feeding device, in order to then be introduced directly into the mold, for example, via the feeding device or with the intermediate use of a filling device.

By introducing the various face concrete mixtures simultaneously, the introduction step is faster and the risk of unintentional mixing of the face concrete mixtures with each other is reduced so that time savings are possible here and, where applicable, a predetermined, more defined or more regular surface play with “sharper” transitions can be created. On the other hand, successive introduction can create a more random, irregular surface play with more fluid transitions, which proves to be favorable in certain applications, since it gives the surface of the floor covering elements, in particular, a natural stone appearance and a more natural character.

In accordance with a still preferred embodiment, the first and second face concrete mixtures are fed into the mold for introducing together and preferably simultaneously by means of a feeding device designed as a common feeding device. This results in the advantage of time savings and a structurally simple construction of the device for manufacturing floor covering elements. In particular, chaotic filling of the mold is also possible.

Preferably, the first and second face concrete mixtures are charged onto the compressed core concrete in such a way that the face concrete layer, which extends over an upper surface of the floor covering element, is formed by at least one first face concrete layer section comprising the first face concrete mixture and at least one second face concrete layer section comprising the second face concrete mixture, in particular, that the face concrete layer is formed by a plurality of different face concrete layer sections.

Preferably, the face concrete introduced onto the compressed core concrete and comprising the first and second face concrete mixture is distributed on the core concrete layer by means of a distribution device before compression, wherein the first and second face concrete mixture can preferably be mixed and/or partially blended at least in sections. The distribution of the face concrete can be carried out, for example, by spreading or warping using a distribution device designed as a spreading and or warping device. Depending on the application and/or individual embodiment, a more diverse and/or random surface play can be created, in particular, by additional sectional blending and/or partial mixing, which further enhances the natural stone-like appearance or the natural character of the floor covering elements. Marblings can also be created in this way.

In accordance with a particularly preferred embodiment of the method, additional face concrete mixtures are prepared and provided and the face concrete used for charging onto the compressed core concrete also comprises at least one proportion of one or a plurality of the other face concrete mixtures. By using more than two face concrete mixtures, a varied, diverse and diverse surface play can be favorably created. In particular, this can be used to achieve a natural appearance of the concrete paving stones.

For example, a first face concrete mixture can be described as a coarse, in particular, as a pervious face concrete mixture of a first color, a second face concrete mixture as a coarse, in particular, as a pervious face concrete mixture of a second color, a third face concrete mixture as a fine, in particular, as a structure-dense face concrete mixture of the first color, and a fourth face concrete mixture as a fine, in particular, as a structure-dense face concrete mixture of the second color can be used. The face concrete layer sections created by using the four aforementioned face concrete mixtures, including the various mixing sections or mixing areas that are also created, create a surface play with numerous transitions, both in terms of color nature as well as in terms of “fineness” or “density” of the surface. In particular, the natural appearance of the concrete paving stones can be enhanced, for example, an almost real travertine look can be created.

It is particularly preferable to introduce the face concrete mixtures into the mold in fixed or randomly selected proportions. Being particularly preferred, the determination and/or selection of the proportions of the face concrete mixtures is automated, in particular, controlled, preferably program-controlled. In particular, the feeding of the proportions of the face concrete mixtures for insertion into the mold is also preferably automated, in particular, controlled, preferably program-controlled.

In the present case, the face concrete layer is preferably produced with a layer thickness in a range of 4 mm to 15 mm, preferably in a range of 6 mm to 12 mm and particularly preferably from 8 mm to 10 mm.

In accordance with a particularly preferred embodiment variant, at least one other concrete material is introduced into the mold and compressed before the core concrete is introduced into at least one mold and/or before the face concrete is charged onto the compressed core concrete. This creates at least one additional layer of concrete, wherein the further layer of concrete is arranged on the side of the core concrete layer that is turned away from the face concrete layer and/or wherein the further concrete layer is arranged between the core concrete layer and the face concrete layer. Such additional concrete layers can be designed, for example, as concrete layers to regulate water permeability or water storage, or as reinforcement layers to strengthen compressive strength and mechanical strength, or they can be designed in such a way that they serve as displacement protection.

The present invention also comprises a device for manufacturing floor covering elements, wherein the device comprises at least a paving stone machine with at least one mold. The device comprises at least a first storage container for the provision of a first face concrete mixture, at least a second storage container for the provision of a second face concrete mixture and at least one feeding device for feeding the face concrete mixtures in the direction to the mold. The storage containers are equipped with an adjustable, in particular, controllable, outlet for the controlled distribution of the face concrete mixtures. The feeding device is designed to receive the face concrete mixtures from the storage containers and transport them in the direction to the mold.

Preferably, the at least one feeding device is also designed to introduce the face concrete mixtures into the mold or to feed them to a filling device for filling the mold.

Each storage container is preferably assigned a measuring and/or dosing device for the volume-accurate and/or dosed discharge of the face concrete mixtures.

Particularly preferable is a control and/or regulation unit that communicates with the storage containers, with the measuring and/or dosing device and/or with the feeding device, and the supply of the face concrete mixtures can be controlled and adjusted, in particular, program-controlled via at least one control routine executed in the control and/or regulation unit.

Furthermore, at least one distribution device for distributing the face concrete in the mold is also preferred, wherein the distribution device is preferably movable.

Furthermore, the present invention relates to a floor covering element made of concrete, in particular, a concrete paving stone or concrete slab, comprising at least a multi-layer concrete block body with at least one concrete-block lower face suitable for being laid on a foundation layer of a underlying surface and a concrete-block upper face opposite thereto. The multi-layer concrete block body comprises at least one core concrete layer and at least one face concrete layer. According to the invention, the face concrete layer comprises at least one first face concrete section and at least one second face concrete section, wherein the first face concrete section comprises a first face concrete mixture and the second face concrete section a second face concrete mixture which differs from the first face concrete mixture, wherein the floor covering element thus comprises a surface play on an upper surface on the concrete-block upper face and wherein the at least a first face concrete section comprises a non-fines porous concrete material and the at least second face concrete section comprises a structurally dense concrete material.

The face concrete layer preferably comprises a plurality of face concrete sections, wherein the face concrete sections are randomly and irregularly distributed over the concrete-block upper face.

Further embodiments, advantages and possible applications according to the invention also result from the following description of exemplary embodiments and from the figures. All described and/or pictorial features are in principle the object according to the invention on their own or in any combination, regardless of their combination in the claims or their reference. The content of the claims is also made part of the description.

### BRIEF DESCRIPTION OF THE DRAWINGS

The invention will be explained in more detail in the following based on the exemplary embodiments in connection with the drawings. The figures show:

FIG. 1 in a roughly schematic and highly simplified partial sectional view, a section of an embodiment of a device for manufacturing a floor covering element, in a state during the introduction of face concrete into a mold;

FIG. 2a in a roughly schematic and highly simplified partial sectional view, a section of an embodiment of the device for manufacturing a floor covering element, in a state during the distribution of face concrete;

FIG. 2b in a roughly schematic and greatly simplified partial sectional view, a section of an embodiment of the device for manufacturing a floor covering element, in a state during the compression of the concrete;

FIG. 3 very simplified and roughly schematically sketched, a section of an embodiment of the device with a plurality of storage containers and a feeding device,

FIG. 4 very simplified and roughly schematically illustrated, a perspective view of an embodiment of a floor covering element with surface play and

FIG. 5 a very simplified and roughly schematic view of a further embodiment of a floor covering element with surface play.

### DETAILED DESCRIPTION OF THE INVENTION

For identical or identical-looking elements according to the invention, identical reference numbers are used in the figures. Furthermore, for the sake of clarity, only reference numbers are displayed in the individual figures that are necessary for the description of the respective figure.

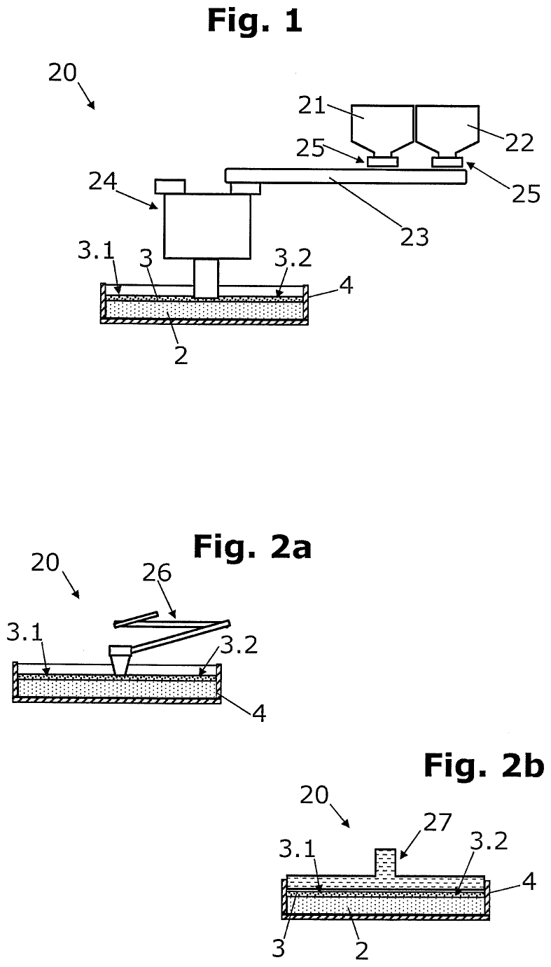

With reference to FIGS. 1 as well as 2a and 2b, the present method for manufacturing floor covering elements 1 (not clearly visible in FIGS. 1 to 2b; see FIGS. 4, 5) is described as an example. FIGS. 1 to 2b sketch individual, selected method steps purely as examples and show, in each case in a highly simplified and only roughly schematic way, views or partial sectional views of the respective sections of a device for manufacturing the floor covering elements 1, as it can be used to carry out the method. The figures depict, for example, a paving stone machine 20 encompassed by the device as well as other associated units or devices that are preferably provided for in the device.

In the method, the floor covering elements 1 are manufactured in the paving stone machine 20 as multi-layer floor covering elements 1, each of which comprises at least one core concrete layer 2 made of core concrete and at least one face concrete layer 3 made of face concrete.

In order to manufacture the floor covering element 1, in the present method in the examples shown, the core concrete is first introduced into a mold 4 provided for the paving stone machine 20 and then compressed, which forms the core concrete layer 2. For reasons of simplification only, the mold 4 is shown in the figures as a single shape for a floor covering element 1, i.e., as the mold 4 with only one recess to accommodate the concrete material, but it is to be understood that the mold 4 can of course also be a mold 4 for a plurality of floor covering elements 1, which then correspondingly comprises a plurality of recesses and each of the recesses is designed to form a floor covering element 1. In this case, the mold 4 can also be referred to as formwork mold or basic formwork mold.

The step of introducing the core concrete into the mold 4, which can also be understood as grouting or pouring the core concrete, is not shown in more detail in the figures, but it is done, for example, by means of a filling device 24 provided for the paving stone machine 20, by means of which the core concrete is removed from a corresponding storage container and fed into the mold 4, for example, with the help of suitable pumps or with other suitable means of transport known to the person skilled in the art.

The filling device 24 preferably comprises a filler neck that extends into the mold 4 so that the core concrete can be introduced in as cleanly and splash-free as possible. For example, the filling device 24 can include a funnel-like filling vessel that supports the filler neck. The filling vessel and/or the filler neck can, for example, be connected to other units of the filling device 24 via a flexible fitting, for example via a hose, and/or, in particular, to a concrete supply. In particular, the filler neck or the entire filling device 24 is movable in relation to the mold 4, preferably height-adjustable as well as movable, and, in particular, movable both in the x-direction and in the y-direction in relation to a plane accommodating the mold 4 so that uniform filling of the mold 4 can be facilitated or ensured.

In a next sub-step of the manufacturing method, the core concrete introduced into the mold 4 is compressed, wherein the paving stone machine 20 comprises a compression device, for example a press or a punch 27. The compacting of the core concrete is not explicitly evident from the figures, but it can be done in a similar way to FIG. 2b, but before the face concrete is introduced into the mold 4. The core concrete can also be compressed by shaking.

In another next sub-step of the method, which is outlined in the highly simplified illustration of FIG. 1, a face concrete is charged onto the compressed core concrete, namely the prepared core concrete layer 2, thereby forming a face concrete layer 3.

The face concrete layer 3 is produced from a first face concrete mixture 3.1 and a second face concrete mixture 3.2. Each of the face concrete mixtures 3.1, 3.2 is prepared and provided in an own storage container 21, 22, namely the first face concrete mixture 3.1 in the first storage container 21 and the second face concrete mixture 3.2 in the second storage container 22. From each of these two storage containers 21, 22, a predetermined quantity of the respective face concrete mixtures 3.1, 3.2 is withdrawn or discharged, fed to a feeding device 23 and via this feeding device 23 the two face concrete mixtures 3.1, 3.2 are conveyed in the direction of the mold 4.

The face concrete used to be charged onto the compressed core concrete thus comprises at least one proportion of the first face concrete mixture 3.1 and at least one proportion of the second face concrete mixture 3.2.

The first and second face concrete mixtures 3.1 and 3.2 are different from each other and differ, for example, in that an aggregate, in particular, sand comprising a first particle size distribution is used for the preparation of the first face concrete mixture 3.1 and that an aggregate, in particular, sand comprising a second particle size distribution is used for the preparation of the second face concrete mixture 3.2. The first and second particle size distributions of the respective aggregates are chosen differently.

In the present case, the particle size distribution can also be understood as the average particle size or average particle size in the aggregate. For example, the first particle size distribution is in a range of 0 mm to 2 mm (this can also be referred to as particle group 0/2) and the second particle size distribution is in a range of 2 mm to 4 mm (this can also be referred to as particle group 2/4).

In the example shown in accordance with FIG. 1, the withdrawing or discharge or transfer of the respective face concrete mixtures 3.1, 3.2 from the associated storage containers 21, 22 as well as the transfer of the face concrete mixtures 3.1, 3.2 to the feeding device 23 is carried out by means of a respective adjustable, in particular, controllable, outlet with which each of the storage containers 21, 22 of the embodiment shown by way of example is equipped and which is required for a controlled discharge of the face concrete mixtures 3.1, 3.2. In order to discharge the face concrete mixtures 3.1 and 3.2 in a quantity-accurate and/or dosed manner, a measuring and/or dosing device 25 is assigned to each storage container 21, 22 or each associated outlet in the embodiment in accordance with FIG. 1.

The adjustable, in particular, controllable, outlet of the storage containers 21, 22 and, in particular, the measuring and/or dosing device 25 are, for example, in communication with a control device or control unit of the device that is not shown in the figures so that the controlled, in particular, quantity-accurate and/or dosed discharge of the respective proportions of the face concrete mixtures 3.1, 3.2 can be controlled by the control device or control unit.

The feeding device 23 of the example shown is designed as a common feeding device for both face concrete mixtures 3.1, 3.2 and is designed, in particular, to receive the face concrete mixtures 3.1, 3.2 discharged from both storage containers 21, 22 from the storage containers 21, 22 and to transport them in the direction of the mold 4. The feeding device 23 can be a conveyor belt or other suitable conveyor.

In the example of FIG. 1, the feeding device 23 is designed in such a way that it interacts with the movable filling device 24 already described above and feeds the face concrete mixtures 3.1, 3.2 to the filling device 24, through which the face concrete mixtures 3.1, 3.2 are finally introduced into the mold 4 and thus are charged onto the compressed core concrete. Alternatively, however, a second filling device may also be provided for the face concrete in order to avoid possible mixing of core concrete and face concrete.

In a further alternative embodiment, the feeding device 23 may also be designed to introduce the face concrete mixtures 3.1, 3.2 directly into the mold 4, i.e., without the interposition of a separately provided filling device. In such an embodiment, which is not shown in the figures, the feeding device 23, for example, comprises a filling section at its end facing the mold 4, through which the face concrete mixtures 3.1, 3.2 can finally be introduced into the mold 4.

The first and second face concrete mixtures 3.1, 3.2 are fed into the mold 4 and charged onto the compressed core concrete in such a way that the face concrete mixtures 3.1, 3.2 form a heterogeneous face concrete mass over the entire feeding and filling step, in which the two face concrete mixtures 3.1, 3.2 exist in unmixed manner or are at most partially blended or partially mixed. The two face concrete mixtures 3.1 and 3.2 are thus at least partly present in the heterogeneous face concrete mass as components occurring next to each other or will remain as such, in particular, until the final completion of the floor covering element 1.

The feeding or introduction of the face concrete mixtures 3.1 and 3.2 into the mold 4 can also be done chaotically or randomly. In an alternative embodiment that is not shown, the face concrete mixtures 3.1, 3.2 can also be provided in a common container and fed and introduced from this into the mold 4.

During and/or after the face concrete has been introduced into the mold 4, the face concrete introduced on the compressed core concrete and comprising the first and second face concrete mixtures 3.1, 3.2 can optionally be distributed on the core concrete layer 2 by means of a distribution device 26, as indicated in FIG. 2a. For example, distribution can be carried out by warping or spreading, wherein in this step of warping or spreading, depending on the application and/or individual design wishes, the first and second face concrete mixtures 3.1, 3.2 can also be blended and/or partially mixed in certain areas, for example, in the way designated for creating a marbling. For warping or spreading, the distribution device 26 comprises, in particular, a suitable warping and/or spreading tool.

As outlined in FIG. 2b, the face concrete is compressed after introducing onto core concrete layer 2—and, where applicable, after optional distribution-again with the help of the press or punch 27. Ultimately, the core and face concrete are cured.

Due to the use of face concrete, which consists of at least one proportion of the first and second face concrete mixtures 3.1, 3.2 respectively for manufacturing face concrete layer 3 and due to the supply and introduction of the respective components of the first and second face concrete mixtures 3.1, 3.2 described above, the face concrete layer 3, which extends over an upper surface O on a concrete-block upper face 1.2 (see FIGS. 4 and 5) of the floor covering element 1, is formed by at least one first face concrete layer section 6.1 comprising the first face concrete mixture 3.1 and at least one second face concrete layer section 6.2 comprising the second face concrete mixture 3.2.

With reference to FIGS. 4 and 5, various exemplary floor covering elements 1, which are manufactured by means of the present method, are now described in more detail. FIGS. 4 and 5 each show a perspective view of a floor covering element 1 in a very simplified and roughly schematic illustration.

As already explained above in connection with the manufacturing method, the floor covering elements 1 are designed as multi-layer concrete blocks and each comprise a multi-layered concrete block body, essentially cuboid in the example of the figures, with a core concrete layer 2 and a face concrete layer 3. The floor covering element 1 or the concrete block body comprises a specified format with a length L and a width B and comprises at least one concrete-block lower face 1.1 suitable for laying on a foundation layer of an underlying surface and a concrete-block upper face 1.2 opposite thereto, along which the upper surface O of the floor covering element 1 extends.

Projections 5, such as ribbed or nose-like projections 5, may be provided on the lateral surfaces of floor covering element 1 (see FIG. 5) for example, which serve as spacers or spacer lugs and, when laying floor covering elements 1 in bond, ensure that a minimum distance between the respective adjacent floor covering elements 1 is maintained in the laid surface structure, thereby creating joints with a specified minimum width.

The upper surface O is formed by the face concrete layer 3, which comprises a layer thickness d, which is about 10 mm in the examples shown. Face concrete layer 3 comprises a plurality of face concrete layer sections 6.1, 6.2, 6.3, 6n, which differ in terms of their visual and/or haptic surface appearance or structure.

For the example shown in FIG. 4, two different face concrete mixtures 3.1, 3.2 were used to create the face concrete layer 3 so that the floor covering element 1 comprises a first and a second face concrete layer section 6.1, 6.2 on its concrete-block upper face 1.2. The face concrete layer sections 6.1, 6.2 are visible on the upper surface O and thus form or create a surface effect or a surface play. In the example shown, the surface effect or surface play is a transition from a finer, smoother surface to a coarser, rougher surface, due to the face concrete mixtures 3.1, 3.2 used in each case, which are produced with aggregates of different particle sizes.

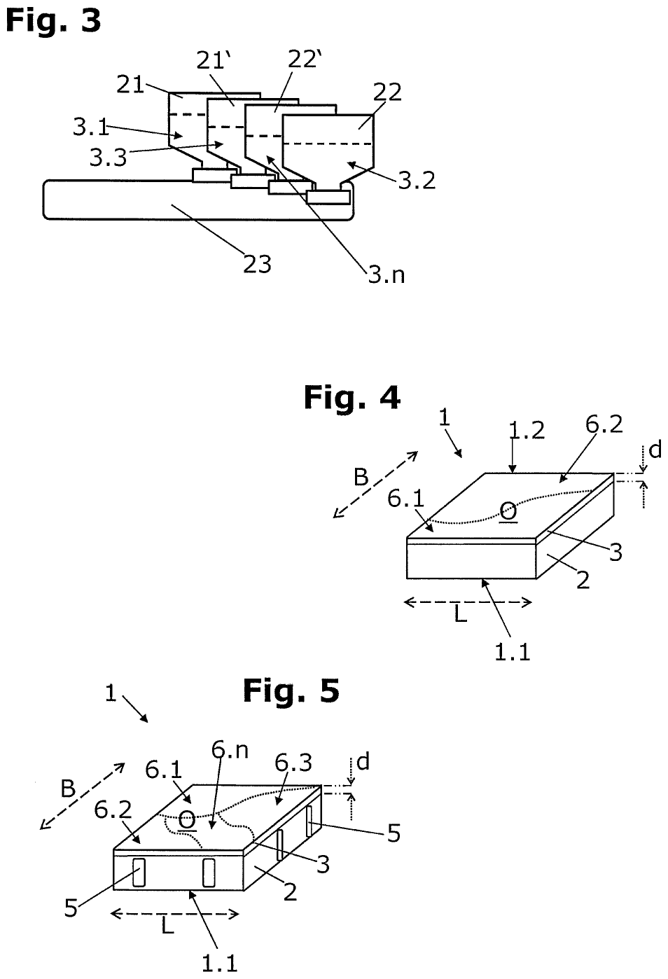

In the example shown in FIG. 5, face concrete layer 3 is produced using four different face concrete mixtures 3.1, 3.2, 3.3, 3.n, wherein the four different face concrete mixtures 3.1, 3.2, 3.3, 3.n are provided in four separate storage containers 21, 22, 21′, 22′ for manufacturing the exemplary floor covering element 1, as FIG. 3 shows by way of example. The four face concrete mixtures 3.1, 3.2, 3.3, 3.n can in turn be fed via a common feeding device 23 and introduced into the mold 4 so that the finished floor covering element 1 comprises at least one first to fourth face concrete layer section 6.1, 6.2, 6.3, 6.n on its concrete-block upper face 1.2.

Also in this case, the face concrete layer sections 6.1-6.n are visible on the upper surface O and thus form or create a surface effect or a surface play.

Depending on the type of introduction of face concrete mixtures 3.1, 3.2, 3.3, 3.ninto the mold 4 and depending on whether a step for distribution, in particular, warping or spreading, or partial mixing is carried out after introduction, different face concrete layer sections 6.1, 6.2, 6.3, 6.n can, of course, also be produced when a plurality of face concrete mixtures 3.1, 3.2, 3.3, 3.n are used, which exceed the number of face concrete mixtures 3.1, 3.2, 3.3, 3.n used.

In the method for manufacturing floor covering elements 1, both the number of face concrete mixtures 3.1, 3.2, 3.3-3.n used as well as a desired composition of the available face concrete mixtures 3.1, 3.2, 3.3-3.n can be freely selected. The proportions of the respective face concrete mixtures 3.1, 3.2, 3.3-3.n, i.e., their respective proportions in the face concrete can also be freely selected. The determination or selection of the number of face concrete mixtures 3.1, 3.2, 3.3-3.n, their composition and the corresponding proportions of the respective face concrete mixtures 3.1, 3.2, 3.3-3.n used may be carried out in a predetermined manner according to fixed specifications or may be selected at random.

The feeding, and, in particular, also the introduction of the respective proportions of the face concrete mixtures 3.1, 3.2, 3.3-3.n into the mold 4 can be carried out in an automated, in particular, controlled manner, depending on the application and design requirements simultaneously or in successive steps.

Depending on the needs and individual design wishes, the present method can be used to produce floor covering elements 1 whose surface O appears in a natural stone look and, in particular, forms a true-to-life imitation of natural stones. Floor covering elements 1 can be manufactured favorably if they comprise a surface play or a surface effect in which visually and/or haptically different surface sections change, wherein flowing transitions between individual surface sections are just as possible as sharp changes in sections.

### Reference List

1 floor covering element
1.1 concrete-block lower face
1.2 concrete-block upper face
2 core concrete layer
3 face concrete layer
3.1 first face concrete mixture
3.2 second face concrete mixture
3.3, 3.n other face concrete mixture
4 mold
5 projection
6.1-6.n face concrete layer sections
20 paving stone machine
21, 21′ storage container
22, 22′ storage container
23 feeding device
24 filling device
25 measuring and/or dosing device
26 distribution device
27 press or punch
B width of the floor covering element
d layer thickness of the face concrete layer
L length of floor covering element
O upper surface

1. A method for the manufacturing of floor covering elements made of concrete for the manufacturing of concrete paving stones or concrete slabs by a paving stone machine,
wherein the floor covering elements are manufactured as multi-layer floor covering elements and comprise at least one core concrete layer produced from a core concrete and at least one face concrete layer produced from a face concrete, the method comprising the steps of introducing the core concrete into at least one mold and forming a compressed core concrete, wherein the face concrete is then charged onto the compressed core concrete and also compressed, and wherein the core and face concrete are cured, wherein for manufacturing the face concrete layer at least a first face concrete mixture and at least a second face concrete mixture are prepared and provided and the face concrete used to be charged onto the compressed core concrete comprises at least a proportion of the first face concrete mixture and at least a proportion of the second face concrete mixture, wherein the first face concrete mixture is a structurally dense concrete material and the second face concrete mixture is a non-fines porous concrete material.

2. The method according to claim 1, wherein the first and second face concrete mixtures are each prepared and provided in a separate storage container.

3. The method according to claim 1, wherein the first face concrete mixture is prepared with an aggregate comprising a first particle size distribution and the second face concrete mixture is prepared with an aggregate comprising a second particle size distribution, wherein the first and second particle size distributions are different.

4. The method according to claim 1, wherein the first and second face concrete mixtures, for charging onto the compressed core concrete of the core concrete layer, are introduced into the mold simultaneously or in successive steps, wherein the first and second face concrete mixtures for charging the mold are fed preferably via at least one feeding device and/or that the face concrete mixtures are introduced chaotically into the mold.

5. The method according to claim 4, wherein the first and second face concrete mixtures for charging the mold are fed commonly and simultaneously by means of a feeding device designed as a common feeding device .

6. The method according to claim 1, wherein the first and second face concrete mixtures are charged onto the compressed core concrete in such a way that the face concrete layer extending over an upper surface of the floor covering element is formed by at least one first face concrete layer section comprising the first face concrete mixture and at least one second face concrete layer section comprising the second face concrete mixture, in particular, that the face concrete layer is formed by a plurality of different face concrete layer sections.

7. The method according to claim 1, wherein the face concrete charged onto the compressed core concrete and comprising the first and second face concrete mixtures is distributed on the core concrete layer by means of a distribution device prior to compression, wherein the first and second face concrete mixtures are blended at least in sections and/or partially mixed.

8. The method according to any one of the preceding claims, characterized in that claim 1, further comprising additional face concrete mixtures prepared and provided and that the face concrete used for the charging onto the compressed core concrete also comprises at least one proportion of one or a plurality of the further face concrete mixtures (3.3-3.n).

9. The method according to claim 1, wherein the face concrete mixtures are introduced into the mold in fixed or randomly selected proportions, wherein the determination and/or selection of the proportions of the face concrete mixtures and feeding for introduction into the mold is automated.

10. The method according to claim 1, wherein the face concrete layer is produced with a layer thickness in a range of 4 mm to 15 mm.

11. The method according to claim 1, wherein at least one further concrete material is introduced into the mold and compressed before the core concrete is introduced into at least one mold and/or before the face concrete is charged onto the compressed core concrete, thereby producing at least one further concrete layer, wherein the further concrete layer is produced on the side of the core concrete layer facing away from the face concrete layer and/or between the core concrete layer and the face concrete layer.

12. A device for manufacturing floor covering elements, comprising at least one paving stone machine with at least one mold, wherein the device comprises at least a first storage container for the provision of a first face concrete mixture, at least a second storage container for the provision of a second face concrete mixture and at least one feeding device for feeding the face concrete mixtures in the direction to the mold, wherein the storage containers are equipped with an adjustable, controllable outlet for the controlled discharge of the face concrete mixtures and wherein the feeding device is designed to receive the face concrete mixtures (from the storage containers and transport them in the direction to the mold.

13. The device according to claim 12, wherein at least one feeding device introduces the face concrete mixtures into the mold or to feed a filling device for introduction into the mold.

14. The device according to claim 12, wherein a measuring and/or dosing device is assigned to each storage container for the volume-accurate and/or dosed discharge of the face concrete mixtures.

15. The device according to claim 12, whereby a control and/or regulation unit communicates with the storage containers, the measuring and/or dosing device and/or the feeding device is provided and the feeding of the face concrete mixtures can be controlled and adjusted, by at least one control routine executed in the control and/or regulation unit.

16. The device according to, claim 12, wherein at least one distribution device is also provided for distributing the face concrete in the mold, wherein the distribution device is movable.

17. A floor covering element made of concrete, in particular, concrete paving stone or concrete slab, comprising at least one multi-layer concrete block body with at least one concrete-block lower face for laying on a foundation layer of an underlying surface and a concrete-block upper face opposite thereto, wherein the multi-layer concrete block body comprises at least one core concrete layer and at least one face concrete layer, wherein the face concrete layer comprises at least one first face concrete section and at least one second face concrete section, wherein the first face concrete section comprises a first face concrete mixture and the second face concrete section comprises a second face concrete mixture which differs from the first face concrete mixture, wherein the floor covering element thereby comprises a surface play on the upper surface on the concrete-block upper face, and wherein at least one first face concrete section comprises a non-fines porous concrete material and the at least one second face concrete section comprises a structurally dense concrete material.

18. The floor covering element according to claim 17, wherein the face concrete layer comprises a plurality of face concrete sections, wherein the face concrete sections are randomly and irregularly distributed over the concrete-block upper face.
